(19) United States
(12) Patent Application Publication
(10) Pub. No.: US 2007/0116917 A1
(43) Pub. Date: May 24, 2007

(54) Super resolution information storage medium and method of preventing the same from deteriorationpreliminary amendment

(75) Inventors: Hyun-Ki Kim, Hwaseong-si (KR); Joo-Ho Kim, Yongin-si (KR); In-Oh Hwang, Seongnam-si (KR); Du-Seop Yoon, Seongnam-si (KR)

Correspondence Address: STEIN, MCEWEN & BUI, LLP, 1400 EYE STREET, NW, SUITE 300, WASHINGTON, DC, 20005, US

(73) Assignee: SAMSUNG ELECTRONICS CO., LTD., Gyeonggi-do (KR)

(21) Appl. No.: 10/581,722

(22) PCT Filed: Dec. 3, 2004
(86) PCT No.: PCT/KR04/03170

§ 371 Date: Jun. 5, 2006

(30) Foreign Application Priority Data
Dec. 5, 2003 (KR) 10-2003-0088167

(51) Int. Cl. B32B 3/02

(52) U.S. Cl. 428/64.4

(57) ABSTRACT

A information storage medium that reproduces information that is recorded as marks and smaller than a resolution of an incidence beam includes a substrate and a super resolution layer or a thermal absorption layer directly arranged on the substrate without any layer therebetween to reproduce the marks by generating a thermal reaction at a portion where the incidence beam is focused. The information storage medium reproduces super resolution information by preventing the deterioration of reproducing characteristic due to the repeated reproduction of the information storage medium, when reproducing information recorded as marks smaller than a resolution. Thus, the recording density and capacity of the information storage medium can be increased.

### CROSS REFERENCE TO RELATED APPLICATIONS

This application is a national phase of International Application No. PCT/KR2004/003170, filed Dec. 3, 2004, which claims the priority of Korean Patent Application No. 2003-88167, filed on Dec. 5, 2003, in the Korean Intellectual Property Office, the disclosures of which are incorporated herein in its entirety by reference.

### BACKGROUND OF THE INVENTION

1. Field of the Invention

Aspects of the present invention relate to a super resolution information storage medium and a method of preventing the same from deterioration, and more particularly, to an information storage medium that reproduces information that is recorded as marks smaller than the resolution of a reproducing beam, and of preventing deterioration due to repeated reproduction and a method of preventing the same from deterioration.

2. Description of the Related Art

An optical recording medium is used as an information storage medium for an optical pickup device that records and reproduces information in a non-contacting manner. As information storage industries are developed, it is desirable to increase the recording density of information. To this end, an information storage medium that reproduces information having recording marks that are smaller than the resolution of a laser beam, by using a super resolution phenomenon, is desirable.

Examples of an information storage medium include a read only memory (ROM) for reproducing recorded information, a write once read many memory for possibly recording once, and a rewritable memory that allows erasing and rewriting information.

In the case of a ROM, information is recorded on a substrate as pit type marks, and the information is reproduced by using the reflectivity difference of the reproducing beams. In other words, the information is reproduced by using the fact that the reflectivity amount of the beam is large where pits exist and the reflectivity amount of the beam is small where pits are absent.

As information storage technologies are developed, performance requirements of the information storage medium are increased, most of all, the capacity of the storage medium. The increase of the capacity of the storage medium depends on how minutely marks can be recorded in a limited area of the storage medium and how precisely the recorded marks can be reproduced.

More specifically, the performance of reproducing information depends on the decrease of the wavelength of the light source that is used to reproduce the information, and the increase of the numerical aperture of an object lens. However, there is a limit in providing a laser having a short wavelength, and the cost of manufacturing an object lens with a large numerical aperture is high. In addition, as the numerical aperture of the object lens is increased, the working distance between the optical pickup and the information storage medium is reduced, thus the optical pickup may collide against the information storage medium and the information recorded on the storage medium may be damaged. Accordingly, it is difficult to increase the capacity and the density of an information storage medium.

Furthermore, when the wavelength of a light source for reproducing information from a storage medium is λ and the numerical aperture of an object lens is NA, λ/4NA is the limit of the reproducing resolution. Thus, the reproduction of information from the storage medium may be impossible even when recording marks are formed to be extremely small. In other words, a beam radiated from a light source cannot distinguish recording marks smaller than λ/4NA, thus the reproduction of the information from such recording marks has been impossible.

However, a super resolution phenomenon, which allows recorded marks having a size below the limit of resolution to be reproduced, has been observed, and studies of the super resolution phenomenon have been carried out. According to the super resolution phenomenon, the recorded marks having a size of below the limit of the resolution can be reproduced, thus a super resolution storage medium can increase the density and the capacity of the medium.

In order for a super resolution storage medium to be widely used, recording characteristics and reproducing characteristics required for an information storage medium should be satisfied. Here, the most important characteristic is a tracking error signal. More specifically, the super resolution information storage medium uses a recording beam and a reproducing beam whose powers are relatively higher than those used for a conventional information storage medium. Thus, it is important to normally detect the tracking error signals.

### SUMMARY OF THE INVENTION

Aspects of the present invention provide an information storage medium that secures reproducing stability and reliability by preventing a reproducing characteristic from being deteriorated by the effects of repeatedly radiating a reproducing beam, and a method of preventing the same from deterioration.

According to an aspect of the present invention, there is provided an information storage medium that provides reproducing of information that is recorded as marks smaller than a resolution of an incidence beam, comprising a substrate and a super resolution layer directly arranged on the substrate without any layer therebetween to reproduce the marks by generating a thermal reaction at a portion where the incidence beam is focused.

According to an aspect of the present invention, the marks are formed on the substrate as pit type marks.

According to an aspect of the present invention, the super resolution layer is formed of a material selected from metal oxides formed of PtOₓ, AuOₓ, PdOₓ, or AgOₓ, and a polymer compound.

According to an aspect of the present invention, the information storage medium further includes at least one thermal absorption layer that absorbs the heat of the incidence beam.

According to an aspect of the present invention, the thermal absorption layer is formed of any one of a Ge—Sb—Te-based alloy and an Ag—In—Sb—Te-based alloy.

According to an aspect of the present invention, a dielectric layer may be arranged between the super resolution layer and the at least one thermal absorption layer.

According to another aspect of the present invention, there is provided an information storage medium that provides reproducing of information that is recorded as marks smaller than a resolution of an incidence beam, comprising a substrate and a thermal absorption layer directly arranged on the substrate without any layer therebetween to reproduce the marks by generating a thermal absorption at a portion where a reproducing beam is focused.

According to still another aspect of the present invention, there is provided a method of preventing a reproducing characteristic from being deteriorated, when reproducing information that is recorded as marks, from an information storage medium including a substrate on which the marks smaller than a resolution are recorded and a thermal absorption layer and/or a super resolution layer reproducing the marks, the method comprising radiating a reproducing beam higher than a predetermined temperature to the substrate to generate a thermal reaction on the thermal absorption layer and/or the super resolution layer, and exhausting a heat from the reproducing beam from the substrate by omitting a layer that disturbs the flow of the heat from the reproducing beam between the substrate and the thermal absorption layer or the substrate and the super resolution layer.

### BRIEF DESCRIPTION OF THE DRAWINGS

The above and other features and advantages of the present invention will become more apparent and more readily appreciated by describing in detail exemplary embodiments thereof with reference to the accompanying drawings in which:

FIGS. 1A and 1B are sectional views illustrating information storage media according to an embodiment of the present invention;

FIG. 2 is a sectional view illustrating an information storage medium according to an embodiment of the present invention;

FIG. 3A is a sectional view illustrating an information storage medium, which is formed to measure a tracking error signal, according to an embodiment of the present invention;

FIG. 3B is a sectional view illustrating a conventional information storage medium having a dielectric material that is formed to measure and compare a tracking error signal with that of an information storage medium according to an embodiment of the present invention;

FIGS. 4A through 4E illustrate the results of tracking error signals measured by changing the power of a reproducing beam on an information storage medium according to an embodiment of the present invention;

FIGS. 5A through 5E illustrate the results of tracking error signals measured by changing the power of a reproducing beam on a conventional information storage medium; and

FIG. 6 is a block diagram illustrating a recording/reproducing system of an information storage medium according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

An information storage medium according to an aspect of the present invention is a super-resolution information storage medium for reproducing information that is recorded as marks having a size exceeding (smaller than) a resolution limit.

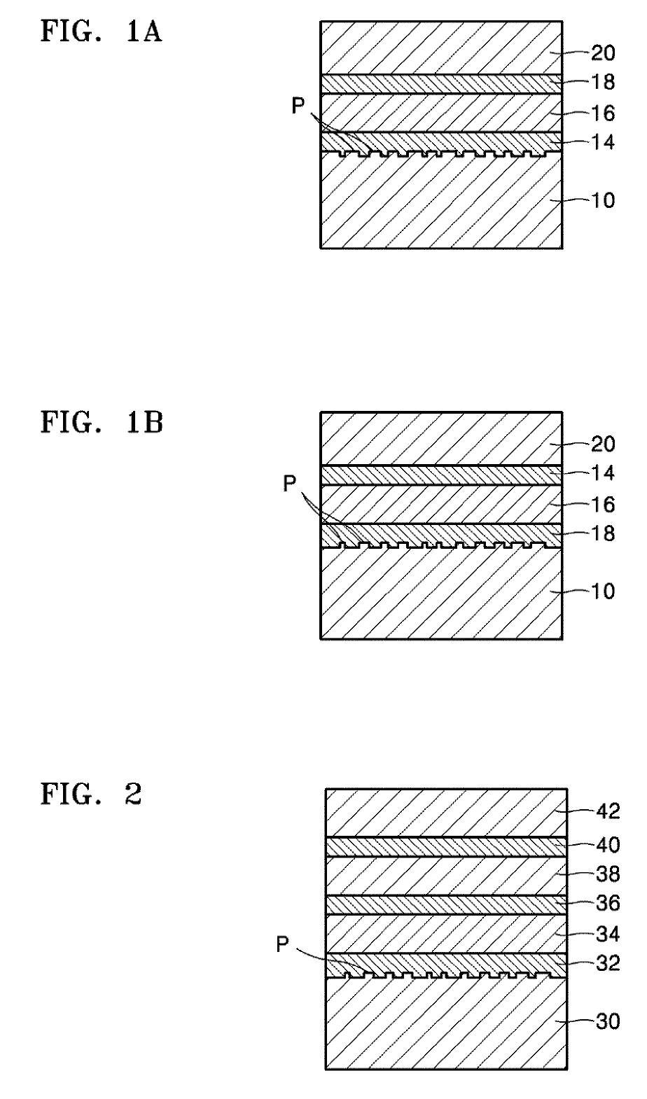

Referring to FIG. 1A, an information storage medium according to an embodiment of the present invention includes a substrate 10, at least one super resolution layer 18, and at least one thermal absorption layer 14. Here, the super resolution layer 18 thermally reacts with a reproducing beam to provide a super resolution phenomenon, and the thermal absorption layer 14 absorbs the heat from the radiation of the reproducing beam in order to induce the super resolution phenomenon with the super resolution layer 18.

As shown in FIGS. 1A and 1B, either the thermal absorption layer 14 or the super resolution layer 18 is directly formed on the substrate 10. In other words, either the thermal absorption layer 14 or the super resolution layer 18 is formed on the substrate 10 without an insertion layer therebetween.

In the information storage medium shown in FIG. 1A, the thermal absorption layer 14 is directly formed on the substrate 10, and the super resolution layer 18 is formed on the thermal absorption layer 14. As shown, a first dielectric layer 16 is formed between the thermal absorption layer 14 and the super resolution layer 18, and a second dielectric layer 20 is formed on the super resolution layer 18. However, it is to be understood that one or both of the dielectric layers 16 and 20 need not be used in all aspects.

In the information storage medium shown in FIG. 1B, the super resolution layer 18 is directly formed on a substrate 10 and the thermal absorption layer 14 is formed on the super resolution layer 18. As shown a first dielectric layer 16 is formed between the super resolution layer 18 and the thermal absorption layer 14, and a second dielectric layer 20 is formed on the thermal absorption layer 14. However, it is to be understood that one or both of the dielectric layers 16 and 20 need not be used in all aspects.

The substrate 10 shown in FIGS. 1A and 1B is formed of a material selected from polycarbonate, polymethylmethacrylate (PMMA), amorphous polyolefin (APO), and glass, as non-limiting examples. Pits p are recording marks formed on the substrate 10 to record information. The length of the pits p is smaller than a defined resolution (i.e., λ/4NA).

While not required in all aspects, the super resolution layer 18 may be formed of a metal oxide or a polymer compound. For example, the super resolution layer 18 may be formed of at least one metal oxide selected from PtOₓ, PdOₓ, AuOₓ, and AgOₓ or combinations thereof. Alternatively, the super resolution layer 18 may be formed of a polymer compound such as, for example, C₃₂H₁₈N₈ or H₂PC (phthalocyanine) or combinations thereof. The super resolution layer 18 induces the super resolution phenomenon by thermally reacting with the reproducing beam.

The thermal absorption layer 14 helps the super resolution layer 18 to reproduce the marks smaller than the resolution when the super resolution layer 18 thermally reacts with the reproducing beam.

While not required in all aspects, the thermal absorption layer 14 may be formed of a Ge—Sb—Te-based alloy or an Ag—In—Sb—Te-based alloy, or a combination thereof. The optical characteristic of the thermal absorption layer 14 is changed by the reproducing beam to assist the transformation of the super resolution layer 18. Alternatively, the reproducing beam may be radiated from a lower portion of the substrate 10 toward the substrate 10 or from the opposite direction of the substrate 10.

The thermal absorption layer 14 may be arranged below or above the super resolution layer 18, and it is preferable, but not necessary, that the thermal absorption layer 14 is arranged nearest to the direction of radiating of the reproducing beam. In other words, when the reproducing beam is radiated from a direction that is on an opposite side of the information storage medium from the substrate 10 as shown in FIG. 1B, the thermal absorption layer 14 is arranged above the super resolution layer 18. When the reproducing beam is radiated from the lower portion of the substrate 10, the thermal absorption layer 14 is arranged below the super resolution layer 18 as shown in FIG. 1A. When the reproducing beam is radiated from the opposite direction of the substrate 10, a cover layer (not shown) may be further arranged.

An information storage medium according to another embodiment of the present invention will now be described with reference to FIG. 2. Referring to FIG. 2, the information storage medium includes a substrate 30 and a first thermal absorption layer 32, which is directly formed on the substrate 30 without any layer therebetween. The information storage medium of FIG. 2 differs from the information storage medium of FIGS. 1A and 1 B by including two thermal absorption layers 32, 40.

The first thermal absorption layer 32 is directly formed on the substrate 30, and a super resolution layer 36 is formed above the first thermal absorption layer 32. A second thermal absorption layer 40 is formed above the super resolution layer 36 such that the super resolution layer 36 is between the thermal absorption layers 32 and 40.

In addition, a first dielectric layer 34 is formed between the first thermal absorption layer 32 and the super resolution layer 36, a second dielectric layer 38 is formed between the super resolution layer 36 and the second thermal absorption layer 40, and a third dielectric layer 42 is formed on the second thermal absorption layer 40.

According to an aspect of the invention, the locations of the first thermal absorption layer 32 and the super resolution layer 36 can be exchanged.

When an information storage medium has two thermal absorption layers 32, 40, the information storage medium generates a better reproducing signal characteristic than an information storage medium having one thermal absorption layer.

The substrate 30, the super resolution layer 36, and the thermal absorption layers 32 and 40 may have the same composition as those of an information storage medium according to the embodiment shown in FIGS. 1A and 1B. Thus, the descriptions thereof will be omitted.

Hereafter, a process of reproducing data from an information storage medium according to aspects the present invention illustrated in FIGS. 1A and 1B or FIG. 2 will be described. A reproducing beam is radiated to an information storage medium to reproduce data. Plasmons having a shorter wavelength than the reproducing beam are generated from metal particles of the super resolution layer 18 or 36 to which the reproducing beam is radiated. The plasmons are excited to reproduce marks smaller than the resolution of the reproducing beam. Here, the optical characteristics of thermal absorption layer 14 or layers 32 and 40 may be changed due to the effects of the reproducing beam to affect the super resolution layer 18 or 36.

In order to induce thermal reactions in the super resolution layer 18 or 36 and the thermal absorption layer 14 or layers 32 and 40 to reproduce the marks smaller than the resolution, a reproducing beam with a higher power than a beam used to reproduce a conventional information storage medium is used. Here, the conventional information storage medium denotes an information storage medium from which data is reproduced by a conventional method, other than a super resolution phenomenon.

Since the power of the reproducing beam used for the super resolution information storage medium is high, it is expected that a reproducing characteristic of the super resolution information storage medium will be deteriorated by repeatedly radiating the reproducing beam. When the reproducing characteristic of the information storage medium is deteriorated, the data cannot be reproduced. Accordingly, it is desirable to prevent the reproducing characteristic of the super resolution information storage medium from being deteriorated.

In the information storage medium according to aspects of the present invention, the thermal absorption layer 14 or 32 or the super resolution layer 18 or 36 is directly formed on the substrate 10 or 30 to prevent the reproducing characteristic from being deteriorated.

In order to measure the improvement of the reproducing characteristic of the information storage medium according to aspects of the present invention, tracking error signals of an information storage medium in which an insertion layer is not formed between a substrate 10 or 30 and a thermal absorption layer 14 or 32 or between a substrate 10 or 30 and a super resolution layer 18 or 36, and an information storage medium in which a dielectric layer is inserted between a substrate and a thermal absorption layer or between a substrate and a super resolution layer can be detected and compared.

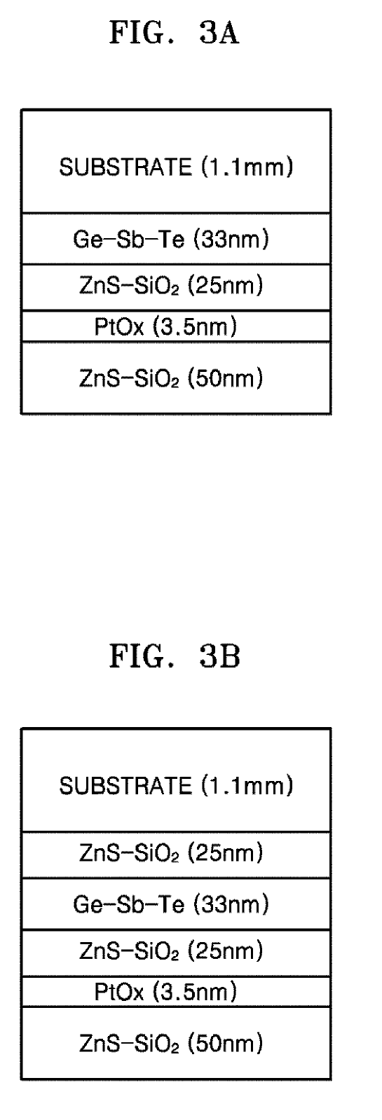

In order to measure and compare tracking error signals, an information storage medium as an example according to an aspect of the present invention is formed of a substrate formed to a thickness of 1.1 mm, a thermal absorption layer of Ge—Sb—Te formed to a thickness of 33 nm, a first dielectric layer of ZnS—SiO₂ formed to a thickness of 25 nm, a super resolution layer of PtOₓ formed to a thickness of 3.5 nm, and a second dielectric layer of ZnS—SiO₂ formed to a thickness of 50 nm, as shown in FIG. 3A.

An information storage medium as a comparative example is formed of a substrate formed to a thickness of 1.1 mm, a first dielectric layer of ZnS—SiO₂ formed to a thickness of 20 nm, a thermal absorption layer of Ge—Sb—Te formed to a thickness of 33 nm, a second dielectric layer of ZnS—SiO₂ formed to a thickness of 25 nm, a super resolution layer of PtOₓ formed to a thickness of 3.5 nm, and a third dielectric layer of ZnS—SiO₂ formed to a thickness of 50 nm, as shown in FIG. 3B.

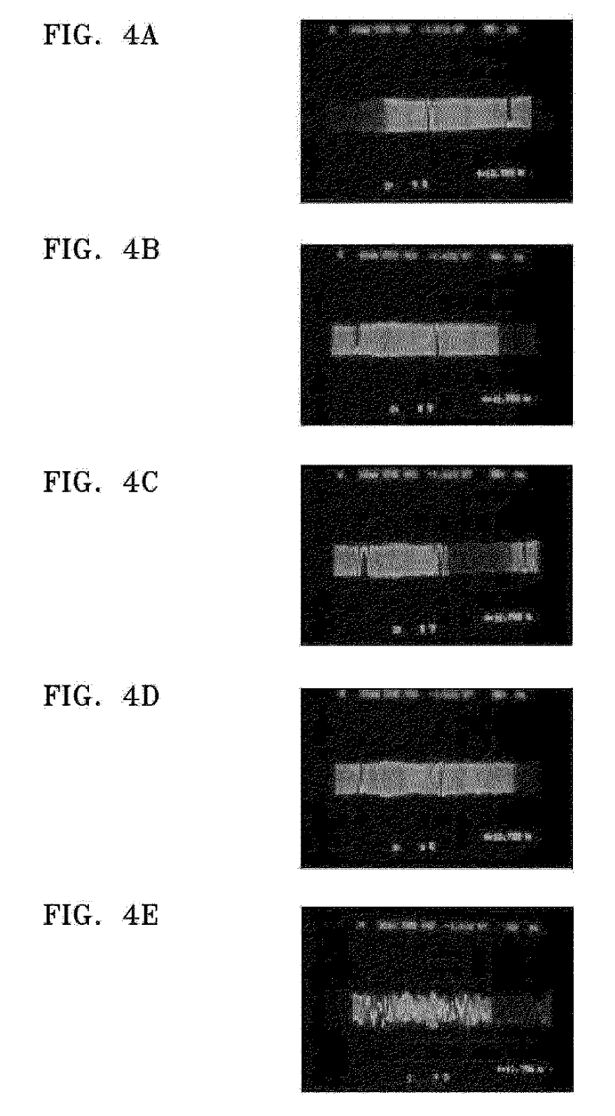

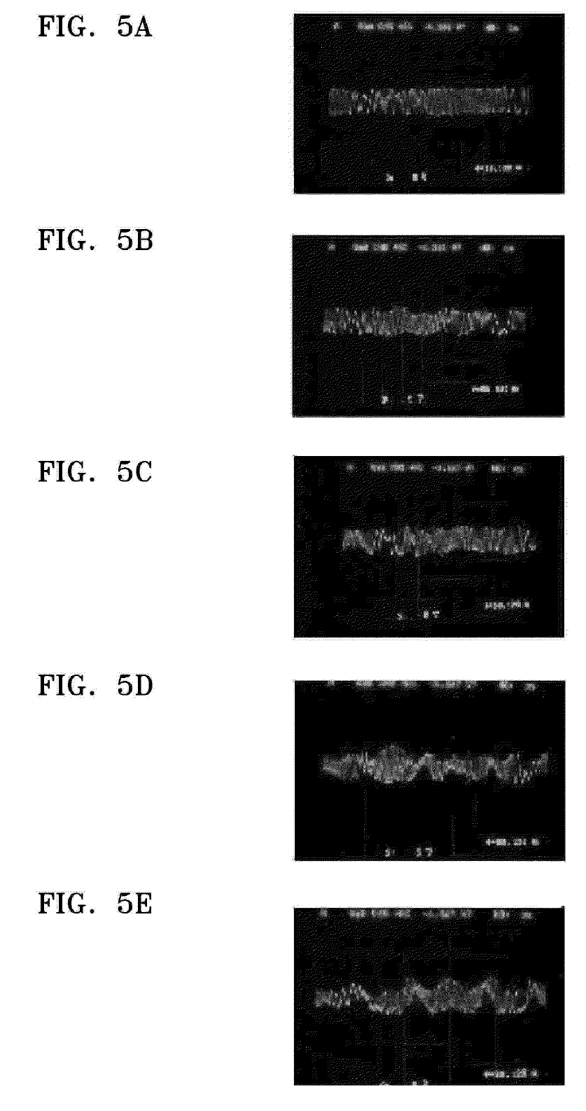

FIGS. 4A through 4E illustrate tracking error signals of the information storage medium according the example of the present invention that are measured while varying the power of a reproducing beam. The tracking error signals of FIG. 4A are obtained by reproducing the information storage medium for one minute by using a reproducing power of 1.0 mW. In addition, the tracking error signals of FIGS. 4B through 4E are obtained by reproducing the information storage medium for one minute by using reproducing powers of 1.2 mW, 1.4 mW, 1.6 mW, and 1.8 mW, respectively. As shown, the tracking error signals are excellent when the reproducing power is in a range from 1.0 to 1.6 mW. When the reproducing power is 1.8 mW, the tracking error signals are less than excellent.

FIGS. 5A through 5E illustrate tracking error signals of the information storage medium according to the comparative example that are measured while varying the power of a reproducing beam. The tracking error signals of FIGS. 5A through 5E are obtained by reproducing the information storage medium as the comparative example for one minute by using reproducing powers of 1.0, 1.1, 1.2, 1.3, and 1.4 mW. As shown, in the case of the information storage medium as the comparative example, the tracking error signals are bad even when the reproducing power is 1.0 mW. When the reproducing power is larger than 1.0 mW, the tracking error signals rapidly deteriorate. According to the result of the tracking error signals, the tracking error signals are unstable when reproducing the information storage medium according to the comparative example, thus the tracking operation cannot be performed due to the fluctuation of the tracking error signals and the deterioration becomes serious.

When considering the above results relating to tracking error signals, it can be seen that the reproducing characteristic of an information storage medium can be improved by directly arranging a thermal absorption layer or a super resolution layer on a substrate. Accordingly, it is shown that when reproducing data from the information storage medium by using a high reproducing power, the deterioration degree and speed can be reduced by using the information storage medium according to aspects of the present invention.

In addition, heat generated from the radiation of the laser beam for reproducing data is accumulated on the information storage medium. Thus, the tracking error signals are deteriorated in the case of the information storage medium according to the comparative example. Accordingly, the deterioration due to the heat can be efficiently prevented by not arranging a layer that prevents the exhaustion of heat between the substrate and the thermal absorption layer or between the substrate and the super resolution layer.

Hereafter, a method of preventing the reproducing characteristic of an information storage medium according to an aspect of the present invention from being deteriorated will be described. First, data is recorded as pit type marks smaller than a defined resolution on the substrate 10 of FIGS. 1A or 1B, or the substrate 30 of FIG. 2. Then, a reproducing beam of higher than a predetermined temperature is radiated to effect a thermal reaction on a thermal absorption layer 14, 32, or 40 and a super resolution layer 18 or 36. As shown, the thermal absorption layer 14 or 32 or the super resolution layer 18 or 36 is directly formed on the substrate 10 or 30, without any layer therebetween, in order to efficiently exhaust the heat from the reproducing beam.

In other words, a layer that prevents the flow of the heat from the reproducing beam is not formed between the substrate 10 or 30 and the thermal absorption layer 14 or 32 or the substrate 10 or 30 and the super resolution layer 18 or 36. Thus, the heat from the reproducing beam is efficiently exhausted to the outside when radiating the reproducing beam to reproduce data from the information storage medium. Accordingly, the deterioration of the information storage medium by repeatedly reproducing the information storage medium can be prevented.

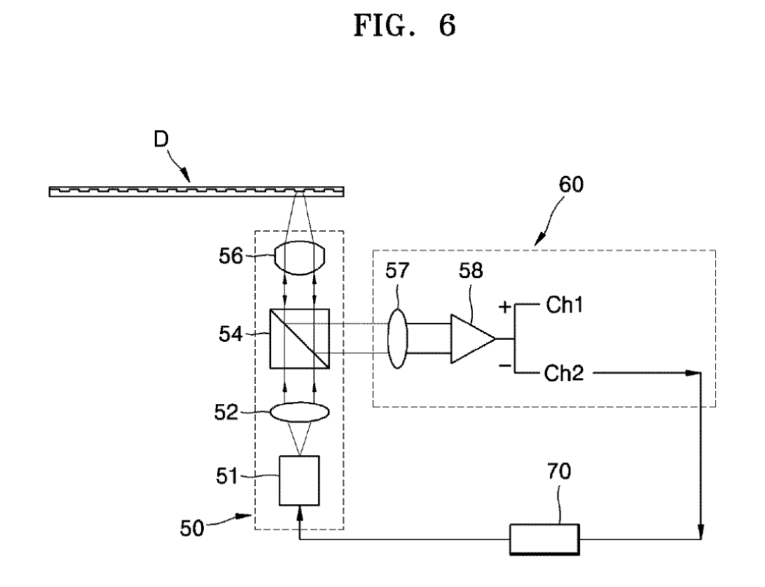

FIG. 6 is a block diagram illustrating a system of recording and/or reproducing an information storage medium according to an aspect of the present invention. A system of recording/reproducing an information storage medium includes a pickup unit 50, a recording/reproducing signal process unit 60, and a control unit 70. More specifically, the system includes a laser diode 51 that radiates a beam, a collimating lens 52 that collimates the beam radiated from the laser diode 51, a beam splitter 54 that converts the path of an incidence beam, and an object lens 56 that concentrates the beam from the beam splitter 54 onto an information storage medium D.

The beam reflected on the information storage medium D is reflected by the beam splitter 54 and received by an optical detector, such as, for example, a quad-optical detector 57. The beam received by the optical detector 57 is converted into electric signals by an operation circuit unit 58 and output as a channel 1 Ch 1 signal, which is detected as an RF signal (in other words, a sum signal), and a differential signal channel Ch2, which is detected as a push-pull type signal.

The control unit 70 radiates a reproducing beam of over a predetermined power, which is selected according to the material characteristic of an information storage medium, through the pickup unit 50, in order to reproduce marks smaller than a defined resolution. When the reproducing beam is focused on the information storage medium D through the pickup unit 50, a super resolution phenomenon occurs on the information storage medium D. The super resolution phenomenon of the information storage medium D according to an aspect of the present invention is described above, thus the descriptions thereof will be omitted.

The beam reflected from the information storage medium D is input to the optical detector 57 through the object lens 56 and the beam splitter 54. The signals input to the optical detector 57 are converted into electric signals by the operation circuit unit 58 and output as RF signals. C/N stability of the information storage medium D is improved due to the thermal conductive layer 20 of FIGS. 1A or 1B or the thermal conductive layer 40 of FIG. 2. Thus, the reproducing characteristic is not deteriorated even after the information storage medium D is repeatedly reproduced. Accordingly, the signal process unit 60 and the control unit 70 can sufficiently record/reproduce data.

As described above, an information storage medium according to aspects of the present invention can reproduce super resolution information by preventing the deterioration of the reproducing characteristic due to the repeated reproduction of the information storage medium, when reproducing information recorded as marks smaller than a defined resolution. Thus, the recording density and capacity of the information storage medium can be increased.

According to an aspect of the present invention, a layer that prevents the flow of heat from a reproducing beam is not formed on a substrate. Accordingly, when the reproducing beam is radiated to reproduce data from the information storage medium, the heat from the reproducing beam is sufficiently exhausted to the outside and the deterioration of the information storage medium by repeatedly reproducing the information storage medium can be prevented.

The information storage medium according to aspects of the present invention may be formed by arranging five layers or seven layers on a substrate. The number of layers and the material of the super resolution layer can vary as described above.

While aspects of the present invention have been particularly shown and described with reference to exemplary embodiments thereof, it will be understood by those of ordinary skill in the art that various changes in form and details may be made therein without departing from the spirit and scope of the present invention as defined by the following claims.

1. An information storage medium that reproduces information that is recorded as marks smaller than a resolution of an incidence beam, the information storage medium comprising:
a substrate having the marks thereon; and
a super resolution layer directly arranged on the substrate without any layer therebetween to reproduce the marks by generating a thermal reaction at a portion where the incidence beam is focused.

2. The information storage medium of claim 1, wherein the marks are formed on the substrate as pit type marks.

3. The information storage medium of any one of claim 1, wherein the super resolution layer is formed of a metal oxides formed of PtOₓ, AuOₓ, PdOₓ, or AgOₓ, polymer compound, or combinations thereof.

4. The information storage medium of claim 1, further including at least one thermal absorption layer that absorbs the heat of the incidence beam.

5. The information storage medium of claim 4, wherein the at least one thermal absorption layer is formed of Ge—Sb—Te-based alloy and/or an Ag—In—Sb—Te-based alloy.

6. The information storage medium of claim 4, wherein a dielectric layer is arranged between the super resolution layer and the at least one thermal absorption layer.

7. An information storage medium that reproduces information that is recorded as marks smaller than a resolution of an incidence beam, the information storage medium comprising:
a substrate having the marks thereon; and
a first thermal absorption layer directly arranged on the substrate without any layer therebetween to reproduce the marks by generating a thermal absorption at a portion where a reproducing beam is focused.

8. The information storage medium of claim 7 is a read only information storage medium.

9. The information storage medium of claim 7, further including a super resolution layer thermally reacting with the reproducing beam.

10. The information storage medium of claim 9, wherein the super resolution layer is formed of metal oxides formed of PtOₓ, AuOₓ, PdOₓ, or AgOₓ, a polymer compound, or combinations thereof.

11. The information storage medium of claim 9, further including an additional thermal absorption layer such that the super resolution layer is between the additional thermal absorption layer and first thermal layer.

12. The information storage medium of claim 9, wherein the first thermal absorption layer is formed of a Ge—Sb—Te—based alloy and/or an Ag—In—Sb—Te-based alloy.

13. The information storage medium of claim 9, wherein a dielectric layer is arranged between the first thermal absorption layer and the super resolution layer.

14. A method of preventing a reproducing characteristic from being deteriorated when reproducing information that is recorded as marks, from an information storage medium including a substrate on which the marks smaller than a defined resolution are recorded and a thermal absorption layer and/or a super resolution layer reproducing the marks, the method comprising:
radiating a reproducing beam higher than a predetermined temperature on the substrate to generate a thermal reaction on the thermal absorption layer and/or the super resolution layer; and
exhausting heat from the reproducing beam from the substrate by omitting a layer of that disturbs the flow of the heat from the reproducing beam between the substrate and the thermal absorption layer or the substrate and the super resolution layer.

15. The method of claim 14, wherein the thermal absorption layer is formed of any one of a Ge—Sb—Te-based alloy and an Ag—In—Sb—Te-based alloy.

16. The method of claim 14, wherein the super resolution layer is formed of a material selected from metal oxides formed of PtOₓ, AuOₓ, PdOₓ, or AgOₓ, and a polymer compound.

17. The information storage medium of claim 1, wherein the resolution of the incidence beam is λ/4NA, wherein λ is the wavelength of the incidence beam and NA is a numerical aperture of an object lens that directs the incidence beam onto the information storage medium

18. The information storage medium of claim 11, wherein the first thermal absorption layer and the additional thermal absorption layer are independently formed of a Ge—Sb—Te-based alloy and/or an Ag—In—Sb—Te-based alloy

19. The information storage medium of claim 11, wherein a dielectric layer is arranged between the additional thermal absorption layer and the super resolution layer.

20. The information storage medium of claim 2, wherein the super resolution layer is formed of a material selected from metal oxides formed of PtOₓ, AuOₓ, PdOₓ, or AgOₓ, and a polymer compound.

21. The information storage medium of claim 2, further including at least one thermal absorption layer that absorbs the heat of the incidence beam.

22. The information storage medium of claim 8, further including a super resolution layer formed on the thermal absorption layer and thermally reacting with the reproducing beam.

23. The method of claim 15, wherein the super resolution layer is formed of any one material selected from metal oxides formed of PtOₓ, AuOₓ, PdOₓ, and AgOₓ, or a polymer compound.

24. An apparatus that reproduces an information storage medium, comprising:
the information storage medium of claim 1;
a light source that directs an incidence beam having a wavelength λ; and
an object lens that concentrates the incidence beam onto the information storage medium, wherein the object lens has a numerical aperture represented by NA and wherein the resolution of the marks recorded on the information storage unit is smaller than λ/4NA.

25. An apparatus that reproduces an information storage medium, comprising:
the information storage medium of claim 7;
a light source that directs an incidence beam having a wavelength λ; and
an object lens that concentrates the incidence beam onto the information storage medium, wherein the object lens has a numerical aperture represented by NA and wherein the resolution of the marks recorded on the information storage unit is smaller than λ/4NA.
